(19) United States
(12) Patent Application Publication
(10) Pub. No.: US 2026/0099868 A1
(43) Pub. Date: Apr. 9, 2026

(54) Systems and Methods of B2B Order Capture and Fulfillment of Unknown Items

(71) Applicant: Blue Yonder Group, Inc., Scottsdale, AZ (US)

(72) Inventors: Sumit Mittal, Frisco, TX (US); Suresh Acharya, Rockville, MD (US); Raghuveer Prasad Nagar, Kota (IN)

(21) Appl. No.: 19/278,225

(22) Filed: Jul. 23, 2025

Related U.S. Application Data
(60) Provisional application No. 63/702,986, filed on Oct. 3, 2024.
(60) Provisional application No. 63/706,879, filed on Oct. 14, 2024.

(51) Int. Cl. G06Q 30/0601; G06Q 30/0204

(52) U.S. Cl. CPC G06Q 30/0603; G06Q 30/02043; G06Q 2220/00

(57) ABSTRACT

A system and method are disclosed for proactive enhancement of a catalog. The method includes determining one or more customer clusters for a seller, determining purchase item trends for the customer clusters, deriving items from the purchase item trends that are not available in a sales catalog of the seller, prioritizing the derived items that are not available in the sales catalog, selecting items of the prioritized items to add to the sales catalog based on at least one threshold, establishing contracts for supplying the selected items, and adding the selected items to the sales catalog. The method further includes where the threshold is based on: constraints, commitments to a customer, priorities, sustainability goals, environmentally friendliness goals, warehouse space limitations and manufacturing capacity limitations.

### CROSS-REFERENCE TO RELATED APPLICATIONS

The present disclosure is related to that disclosed in the U.S. Provisional Application No. 63/702,986, filed Oct. 3, 2024, entitled “B2B Order Capture and Fulfillment of Unknown Items,” and U.S. Provisional Application No. 63/706,879, filed Oct. 14, 2024, entitled “B2C Order Capture and Fulfillment of Unknown Items.” U.S. Provisional Application Nos. 63/702,986 and 63/706,879 are assigned to the assignee of the present application.

### TECHNICAL FIELD

The present disclosure relates generally to order fulfillment and more specifically to order capture and fulfillment.

### BACKGROUND

Retailers utilize catalogs, such as sales catalogs, as inclusive lists of items from which customers may place orders. Such catalogs are generally created, updated, and reviewed by item administrators, and include specifications of each item, such as dimensions, descriptions, identifiers, media, and unique identifiers. However, business-to-business (B2B) may want to place orders for items that are not in internal sales catalogs of retailers, and using existing fulfillment systems requires retailers to reject such orders. Accepting orders that are limited to items included in an internal sales catalog leads to loss of sales and dissatisfied customers. Thus, existing fulfillment systems lead to decreased profit and decreased customer satisfaction, both of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the order capture system, the archiving system, and the planning and execution system of FIG. 1 in greater detail, in accordance with an embodiment;

FIG. 3 illustrates an example method for order fulfillment of unknown ordered items, in accordance with an embodiment;

FIG. 4 illustrates an example method for performing machine-learning-driven item prioritization based on input constraints, in accordance with an embodiment;

FIG. 5 illustrates an example method for proactive enhancement of a catalog, in accordance with an embodiment;

FIG. 6 illustrates an example method for receiving feedback on prioritization and selection, in accordance with an embodiment; and

FIG. 7 illustrates an example method for a reverse image search of an item using generative artificial intelligence, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described below, embodiments of the following disclosure provide systems and methods for capturing orders for business-to-business (B2B) customers of a supply chain or supply chain network. Embodiments make an item identification a non-mandatory attribute on an order and expose one or more supporting information fields for order lines not having an item identification. Embodiments further confirm an order when the order service level agreement (SLA) is predicted to be met by one or more configured constraints.

Embodiments of the following disclosure further determine a catalog item identification based on information in one or more supporting information fields. Systems and methods disclosed herein may search for the item in one or more external sales catalogs using the information in the one or more supporting information fields. Embodiments prioritize search results from the one or more external sales catalogs and establish a contract for a supply and a plan for fulfillment of the order. Embodiments may also initiate fulfillment of the order, and may create and update the item to one or more catalogs.

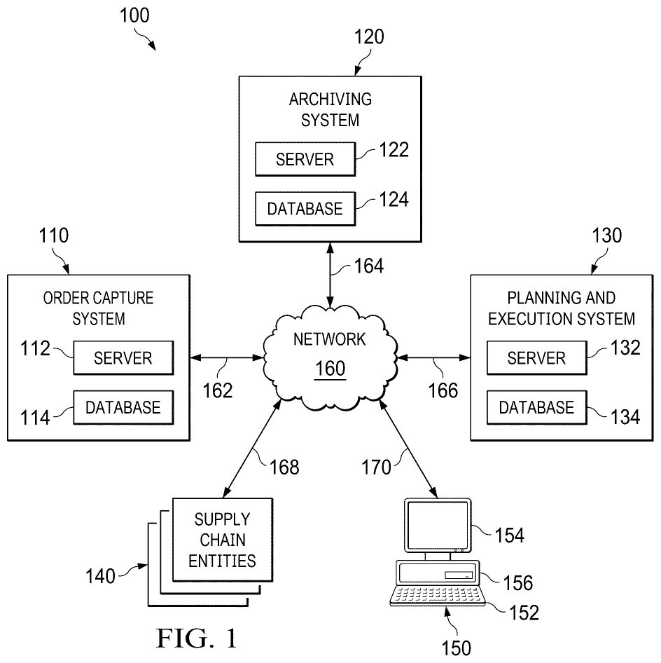

FIG. 1 illustrates supply chain network 100, in accordance with a first embodiment. Supply chain network 100 comprises order capture system 110, archiving system 120, planning and execution system 130, one or more supply chain entities 140, one or more computers 150, network 160, and one or more communication links 162-170. Although a single order capture system 110, a single archiving system 120, a single planning and execution system 130, one or more supply chain entities 140, one or more computers 150, a single network 160, and one or more communication links 162-170 are illustrated and described, embodiments contemplate any number of order capture systems, archiving systems, planning and execution systems, supply chain entities, computers, networks, or communication links, according to particular needs.

In one embodiment, order capture system 110 comprises server 112 and database 114. Although order capture system 110 is illustrated in FIG. 1 as comprising a single server 112 and a single database 114, embodiments contemplate order capture system 110 including any suitable number of servers, databases, serverless computing options, or data stores internal to, or externally coupled with, order capture system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. In embodiments, order capture system 110 provides order fulfillment for one or more unknown ordered items to customers of supply chain network 100, such as customers of a particular retailer or e-commerce platform within supply chain network 100. As used herein, the word “customer” includes individual shoppers or consumers (including humans and automated machines or bots), business or organizational clients, or any other person, machine, or entity that may place an order for goods or services. As described in further detail below, to provide order fulfillment, order capture system 110 may determine a catalog item identification based on information from one or more supporting information fields in an order. Order capture system 110 may search one or more external sales catalogs based on the one or more information fields and prioritize search results to select an item from the search results. In embodiments, order capture system 110 establishes one or more contracts for supply of the item and plans for fulfillment of the order. Order capture system 110 may further initiate fulfillment of the order, as well as create and update the item to one or more catalogs.

Archiving system 120 comprises server 122 and database 124. Although archiving system 120 is illustrated as comprising a single server 122 and a single database 124, embodiments contemplate any suitable number of servers or databases internal to, or externally coupled with, archiving system 120. Server 122 of archiving system 120 may support one or more processes for receiving and storing data from planning and execution system 130 and/or one or more computers 150 of supply chain network 100. According to some embodiments, archiving system 120 comprises an archive of data received from planning and execution system 130 and/or one or more computers 150 and provides archived data to order capture system 110 and/or planning and execution system 130. Server 122 may store the received data in database 124, which may comprise one or more databases or other data storage arrangements at one or more locations local to, or remote from, server 122.

According to an embodiment, planning and execution system 130 comprises server 132 and database 134. Supply chain planning and execution is typically performed by several distinct and dissimilar processes, including, for example, order promising, assortment planning, demand planning, operations planning, production planning, supply planning, distribution planning, execution, pricing, forecasting, transportation management, warehouse management, inventory management, fulfillment, procurement, contract management, and the like. Server 132 of planning and execution system 130 comprises one or more modules, such as, for example, such as, for example, an order promising module, a sourcing module, a scheduling module, and/or a pick-pack-ship module for performing one or more order fulfillment processes. Server 132 stores and retrieves data from database 134 or one or more other locations in supply chain network 100. In addition, planning and execution system 130 operates on one or more computers 150 that are integral to, or separate from, the hardware and/or software that support archiving system 120 and order capture system 110.

One or more supply chain entities 140 may represent one or more suppliers, one or more manufacturers, one or more distribution centers, and one or more multi-channel and/or omni-channel retailers in supply chain network 100, including one or more enterprises. One or more suppliers may be any suitable entity that offers to sell or otherwise provides one or more items or components to one or more manufacturers or buyers. One or more suppliers may, for example, receive an item from a first supply chain entity of one or more supply chain entities 140 in supply chain network 100 and provide the item to another supply chain entity of one or more supply chain entities 140, which in some embodiments may be a buyer, a customer, or an end user. Items may comprise, for example, components, materials, products, parts, supplies, or other items that may be used to produce products. In addition, or as an alternative, an item may comprise a supply or resource that is used to manufacture the item but does not become a part of the item. In embodiments, items may comprise a service, such as an installation service. One or more suppliers may comprise automated distribution systems that automatically transport items to one or more manufacturers based, at least in part, on a supply chain plan having fair-shared items or resources, a material or capacity reallocation, current and projected inventory levels, and/or one or more additional factors described herein.

One or more manufacturers may be any suitable entity that manufactures at least one product. One or more manufacturers may use one or more items during the manufacturing process to produce any manufactured, fabricated, assembled, or otherwise processed item, material, component, good or product. In one embodiment, a product represents an item ready to be supplied to, for example, another supply chain entity one or more supply chain entities 140 (e.g., a supplier), an item that needs further processing, or any other item. One or more manufacturers may, for example, produce and sell a product to a supplier, another manufacturer, a distribution center, a retailer, a customer, or any other suitable person or an entity. Such manufacturers may comprise automated robotic production machinery that produce products based, at least in part, on a supply chain plan having fair-shared items or resources, a material or capacity reallocation, current and projected inventory levels, and/or one or more additional factors described herein.

One or more distribution centers may be any suitable entity that offers to sell or otherwise distributes at least one product to one or more retailers and/or customers. One or more distribution centers may, for example, receive a product from a first supply chain entity of one or more supply chain entities 140 in supply chain network 100 and store and transport the product for a second supply chain entity of one or more supply chain entities 140. Such distribution centers may comprise automated warehousing systems that automatically transport products to one or more retailers or customers and/or automatically remove an item from, or place an item into, inventory based, at least in part, on a supply chain plan having fair-shared items or resources, a material or capacity reallocation, current and projected inventory levels, and/or one or more additional factors described herein.

One or more retailers may be any suitable entity that obtains one or more products to sell to one or more customers. In addition, one or more retailers may sell, store, and supply one or more components and/or repair a product with one or more components. One or more retailers may comprise any online or brick and mortar location, including locations with shelving systems. One or more retailers may further comprise one or more omni-channel retailers. Shelving systems may comprise, for example, various racks, fixtures, brackets, notches, grooves, slots, or other attachment devices for fixing shelves in various configurations. These configurations may comprise shelving with adjustable lengths, heights, and other arrangements, which may be adjusted by an employee of one or more retailers based on computer-generated instructions or automatically by machinery to place products in a desired location.

The same supply chain entity may simultaneously act as any one or more suppliers, manufacturers, distribution centers, and retailers. For example, one or more supply chain entities 140 acting as a manufacturer may produce a product, and the same one or more supply chain entities 140 may act as a supplier to supply a product to another one or more supply chain entities 140. Although one example of supply chain network 100 is illustrated and described, embodiments contemplate any configuration of supply chain network 100 without departing from the scope of the present disclosure.

As illustrated in FIG. 1, supply chain network 100 comprising order capture system 110, archiving system 120, planning and execution system 130, and one or more supply chain entities 140 may operate on one or more computers 150 that are integral to, or separate from, the hardware and/or software that support order capture system 110, archiving system 120, planning and execution system 130, and one or more supply chain entities 140. One or more computers 150 may include any suitable input device 152, such as a keypad, mouse, touch screen, microphone, or other device to input information. Output device 154 may convey information associated with the operation of supply chain network 100, including digital or analog data, visual information, or audio information. One or more computers 150 may include fixed or removable computer-readable storage media, including a non-transitory computer-readable medium, magnetic computer disks, flash drives, CD-ROM, in-memory device, or other suitable media to receive output from and provide input to supply chain network 100.

One or more computers 150 may further include one or more processors 156 and associated memory to execute instructions and manipulate information according to the operation of supply chain network 100 and any of the methods described herein. In addition, or as an alternative, embodiments contemplate executing the instructions on one or more computers 150 that cause one or more computers 150 to perform functions of the methods. An apparatus implementing special purpose logic circuitry, for example, one or more field-programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system having processing and storage devices at one or more locations local to, or remote from, order capture system 110, archiving system 120, planning and execution system 130, and one or more supply chain entities 140. In addition, each of one or more computers 150 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with order capture system 110 and archiving system 120. In the same or another embodiment, one or more users may be associated with planning and execution system 130 and one or more supply chain entities 140.

In one embodiment, order capture system 110 may be coupled with network 160 using communication link 162, which may be any wireline, wireless, or other link suitable to support data communications between order capture system 110 and network 160 during operation of supply chain network 100. Archiving system 120 may be coupled with network 160 using communication link 164, which may be any wireline, wireless, or other link suitable to support data communications between archiving system 120 and network 160 during operation of supply chain network 100. Planning and execution system 130 may be coupled with network 160 using communication link 166, which may be any wireline, wireless, or other link suitable to support data communications between planning and execution system 130 and network 160 during operation of supply chain network 100. One or more supply chain entities 140 may be coupled with network 160 using communication link 168, which may be any wireline, wireless, or other link suitable to support data communications between one or more supply chain entities 140 and network 160 during operation of supply chain network 100. One or more computers 150 may be coupled with network 160 using communication link 170, which may be any wireline, wireless, or other link suitable to support data communications between one or more computers 150 and network 160 during operation of supply chain network 100. Although communication links 162-170 are illustrated as generally coupling order capture system 110, archiving system 120, planning and execution system 130, one or more supply chain entities 140, and one or more computers 150 to network 160, any of order capture system 110, archiving system 120, planning and execution system 130, one or more supply chain entities 140, and one or more computers 150 may communicate directly with each other, according to particular needs.

In another embodiment, network 160 includes the Internet and any appropriate local area networks (LANs), metropolitan area networks (MANs), or wide area networks (WANs) coupling order capture system 110, archiving system 120, planning and execution system 130, one or more supply chain entities 140, and one or more computers 150. For example, data may be maintained locally to, or externally of, order capture system 110, archiving system 120, planning and execution system 130, one or more supply chain entities 140, and one or more computers 150 and made available to one or more associated users of order capture system 110, archiving system 120, planning and execution system 130, one or more supply chain entities 140, and one or more computers 150 using network 160 or in any other appropriate manner. For example, data may be maintained in a cloud database at one or more locations external to order capture system 110, archiving system 120, planning and execution system 130, one or more supply chain entities 140, and one or more computers 150 and made available to one or more associated users of order capture system 110, archiving system 120, planning and execution system 130, one or more supply chain entities 140, and one or more computers 150 using the cloud or in any other appropriate manner. Those skilled in the art will recognize that the complete structure and operation of network 160 and other components within supply chain network 100 are not depicted or described. Embodiments may be employed in conjunction with known communications networks and other components.

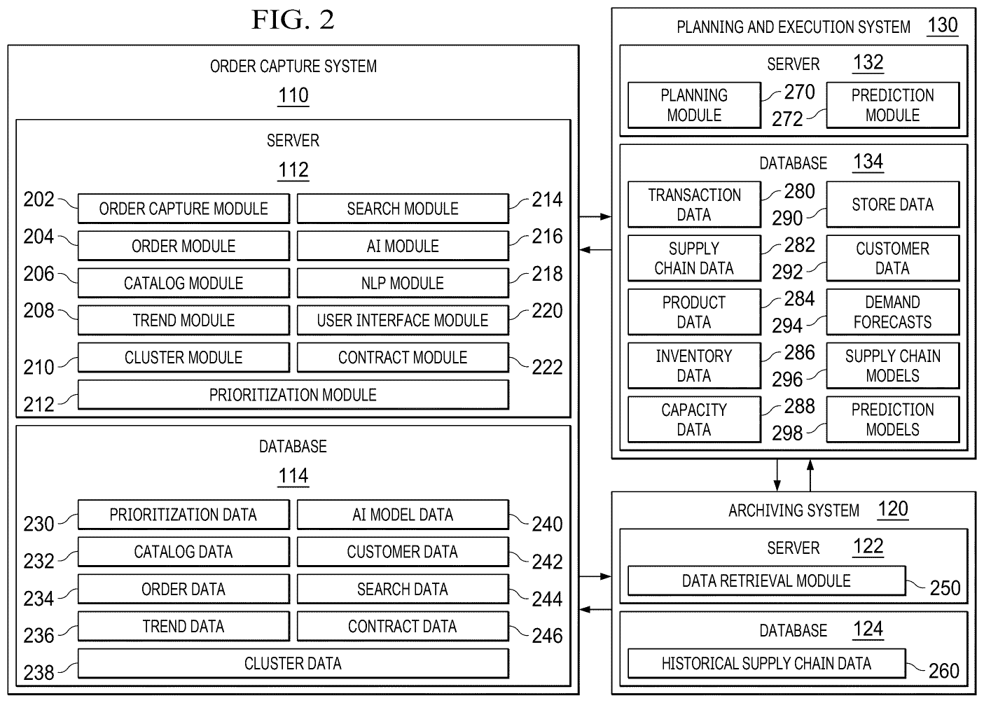

FIG. 2 illustrates order capture system 110, archiving system 120, and planning and execution system 130 of FIG. 1 in greater detail, in accordance with an embodiment. Order capture system 110 may comprise server 112 and database 114, as described above. Although order capture system 110 is illustrated as comprising a single server 112 and a single database 114, embodiments contemplate any suitable number of servers or databases internal to, or externally coupled with, order capture system 110.

Server 112 of order capture system 110 comprises an order capture module 202, order module 204, catalog module 206, trend module 208, cluster module 210, prioritization module 212, search module 214, artificial intelligence (AI) module 216, natural language processing (NLP) module 218, user interface module 220, and contract module 222. Although server 112 is illustrated and described as comprising a single order capture module 202, a single order module 204, a single catalog module 206, a single trend module 208, a single cluster module 210, a single prioritization module 212, a single search module 214, a single AI module 216, a single NLP module 218, a single user interface module 220, and a single contract module 222, embodiments contemplate any suitable number or combination of these located at one or more locations local to, or remote from, order capture system 110, such as on multiple servers or one or more computers 150 at one or more locations in supply chain network 100.

In an embodiment, order capture module 202 integrates and/or coordinates one or more operations and/or functions of order capture system 110. For example, order capture module 202 may integrate one or more operations of one or more modules of order capture system 110 and may manage one or more operations of order capture system 110 through a use of one or more application programming interfaces (APIs). According to embodiments, order capture module 202 provides for fault-tolerant operation of order capture system 110, for example, by providing one or more error handling processes to handle one or more errors in the operation of order capture system 110 and/or operation of order capture system 110 with one or more external systems. Order capture module 202 may also provide a seamless and transparent operation of order capture system 110 in response to one or more changing conditions. By way of example only and not by way of limitation, when demand for orders at order module 204 is high, order capture module 202 may allocate and/or reallocate computing resources to order module 204, such as from a cloud, so that users and/or customers do not experience any noticeable degradation in performance. In another nonlimiting example, when search module 214 is attempting to access an online resource and internet traffic at that online source is high, order capture module 202 may take one or more actions to mitigate any latency and/or timeout issues, such as changing a timeout parameter and/or utilizing another online resource. In addition, or as an alternative, order capture module 202 may initiate fulfillment of an order, as described in further detail below.

In an embodiment, order module 204 receives and/or processes information for one or more orders. Order module 204 may receive supporting information from a customer, such as, for example, one or more order lines which define and/or characterize one or more items desired by a customer. In such an example, the one or more order lines received by order module 204 may omit identifying information, such as, an SKU and/or a UPC code. According to embodiments, order module 204 is configured to receive information in any format, such as text, video, images, verbal input, and the like. Order module 204 may receive the one or more orders from any selling channel, such as, for example, phone, mobile app, website, retail store, call center, chat, and the like. When receiving input via video, order module 204 may apply an algorithm to extract one or more frames from the video using an algorithm, such as, for example, a Fourier transformation or any other suitable algorithm for extracting frames from video. By way of example only and not by way of limitation, a customer may enter text comprising “oil filter,” “Brand X front-end loader,” “next-day delivery,” and an image of a front-end loader owned by the customer as supporting information for an order. In embodiments, order module 204 interacts with a catalog to identify one or more items ordered by a customer. For example, when a current customer places an order for an item and/or service with an identifying descriptor (e.g., SKU, UPC code, etc.), where the identifying descriptor correctly identifies the item and/or service in a catalog, order module 204 processes the order using the identifying descriptor. Order module 204 may receive and/or process any type of order, including long orders, short orders, partial orders, orders that are additions and/or updates of an item to an existing order, and the like. According to embodiments, order module 204 may interface with any module of order capture system 110 and/or with any other external system for processing an order, for example, to expedite fulfillment, process one or more payment transactions, and the like. Order module 204 may also receive information necessary to process an order from any other module in order capture system 110, such as, for example, from search module 214 that has identified a part and/or a supplier from an internet search for an item. Order module 204 may further provide any type of shopping cart for accumulating one or more items being ordered and may persist the shopping cart for any time frame, according to business needs. In embodiments, order module 204 may accept or reject an order from a customer according to various factors, such as whether an item in an order is out of stock or other factors impacting availability. Embodiments further contemplate that order module 204 may track and provide any metrics regarding orders, such as, for example, sales amounts, percentage of items ordered that were in an existing catalog, percentage of items ordered under a contract, and the like.

In an embodiment, catalog module 206 provides access to any type of catalog data 232. Catalog module 206 may provide access to catalog data 232 in response to any type of query, such as, for example, from order module 204. In embodiments, catalog module 206 also provides administration of any kind of data in a catalog. For example, catalog module 206 may comprise an item administrator that may create, update, and/or review any definition and/or information of one or more items in a master catalog before publishing to a sales catalog. Catalog module 206 may further automatically add one or more items to a catalog based on any other operation of order capture system 110 described herein. In some embodiments, catalog module 206 may be configured to require manual intervention to approve or deny entry into the catalog of any item, based on particular needs. Embodiments contemplate that catalog module 206 may provide one or more alerts and/or notifications of one or more items as being recommended for entry into the catalog. In addition, catalog module 206 may provide version management to manage and/or track one or more versions of a sales catalog and/or a master catalog, such as, for example, when a catalog is applicable to a certain region, when a catalog is effective for a certain time frame, and/or the like.

In an embodiment, trend module 208 provides one or more purchase item trends of one or more customer clusters. Trend module 208 may determine one or more trends by analyzing one or more customer purchase histories, any kind of publicly available information, and/or customer service data. A trend identified by trend module 208 may be quantitative, such as, for example, a percentage increase in sales volume for an item, or qualitative, such as, for example, by indicating a sales trend for an item as “high” or “low” and/or that a sales trend for an item indicates the item as “strategic.” According to embodiments, trend module 208 may provide the trend for one or more items in the form of a straight line and/or by fitting one or more curves to determine the trend, use one or more diffusion models and/or product lifecycle models to model and/or estimate one or more sales trends for one or more items (e.g., by modelling where sales volumes are on a diffusion model curve to estimate and/or forecast future sales volumes and/or demand based on that curve), analyze one or more customer purchase histories to determine one or more trends, and/or the like. Trend module 208 may access and/or mine any kind of publicly available information to obtain data for analyzing one or more trends, such as, for example, social media data, reviews on a retailer website for a purchased item, articles written by customers, information posted on a company blog, websites that track market and/or social trends, information from a regulatory complaint system that tracks customer sales trends and preferences, and the like. Embodiments contemplate that trend module 208 may provide any kind of graphic visualization of trend data 236, such as, for example, box and whisker plots, trend line graphs, and the like. In addition, or as an alternative, trend module 208 may import and/or export any data and/or analysis to and/or from external programs, such as spreadsheet and graphing platforms, programming and numeric computing platforms, interpreted, interactive, object-oriented programming platforms, and/or the like.

In an embodiment, cluster module 210 performs any kind of clustering, segmentation, and/or classification of customers and items. Cluster module 210 may determine one or more customer clusters using any classification, segmentation, and/or clustering technique, such as, for example, a K-means algorithm. Data for clustering may comprise any kind of data and/or combinations of data that may be used to group and/or segment customers, including demographic and/or economic data such as company purchase history, company characteristics, market, region, Standard Industrial Classification (SIC) code, and the like. Cluster module 210 may use a simple approach, such as clustering customers based on industry type (e.g., SIC code), or may use a more complex approach, such as by applying a multidimensional analysis to cluster customers using a support vector machine (SVM). Embodiments contemplate that cluster module 210 may combine approaches, for example, to perform a higher level clustering to identify high-level groups and then perform a more detailed clustering to identify one or more sub-group clusters within the high-level groups. In embodiments, cluster module 210 clusters and/or classifies one or more constraints associated with an item, such as, for example, selling constraints, fulfillment constraints, and/or constraints associated with the item. By way of example only and not by way of limitation, a cluster of customers may be associated with delivery constraints of “next day air” because the cluster of customers all operate mission-critical equipment whose lengthy downtime would be undesirable.

In an embodiment, prioritization module 212 prioritizes one or more items from one or more search results by assigning one or more prioritization scores. Prioritization module 212 may prioritize the one or more items based on applying a scoring approach to the one or more items. According to embodiments, prioritization module 212 may utilize a machine learning (ML) algorithm via AI module 216 to perform prioritization using scoring, such as, for example, a K-means clustering algorithm. Prioritization module 212 may further receive positive feedback to improve a clustering approach, for example, from one or more orders for one or more items that were selected and added to a catalog, and negative feedback to improve a prioritization approach, for example, from one or more orders for one or more items that were not selected and added to a catalog.

In an embodiment, search module 214 performs one or more searches for one or more items. Search module 214 may perform a search based on one or more types of supporting information and/or combinations thereof, such as, for example, using a textual description of an item with an associated image. For example, search module 214 may perform an online search to locate an item and/or supplier for an item based on one or more types of supporting information, or may perform an online search for one or more items in one or more online catalogs and/or available online information (e.g., a listing of suppliers providing high voltage electrical machinery and/or an online catalog of a supplier). According to embodiments, search module 214 uses one or more AI and/or ML models from AI module 216, for example, to perform a reverse image search of one or more online sources and/or to search one or more catalogs.

In an embodiment, AI module 216 comprises one or more AI engines that use one or more AI and/or ML models to classify supporting information from one or more orders into a constraint category, such as, for example, into categories of selling and/or fulfillment. For example, AI module 216 may use a SVM approach to classify supporting information into a constraint category, though embodiments contemplate AI module 216 using any kind of classification, segmentation, and/or clustering method to classify supporting information into a constraint category. According to embodiments, AI module 216 uses an AI or ML model to derive a prioritization score for one or more items returned from a search, such as, for example, using a K-means clustering algorithm. AI module 216 may also determine one or more thresholds for prioritizing and/or selecting one or more items. The prioritization for an item may be based upon any kind of constraint, such as a service level agreement, a business constraint, a customer constraint, and the like. In addition, or as an alternative, AI module 216 may use a non-AI method to derive a prioritization score for one or more items returned from a search, such as, for example, weighted scoring prioritization where different weights are configured and/or used for different constraints to derive the final prioritization score. According to embodiments, constraints may be explicit constraints, such as sourcing from a particular region, and/or may be implicit constraints, such as electrical equipment for a European customer may be required to operate with two-hundred thirty volt and fifty hertz electrical power. AI module 216 may derive and/or infer implicit constraints from one or more explicit constraints and/or other supporting information.

In embodiments, AI module 216 uses one or more neural networks to generate an image from one or more types of supporting information, such as, for example, textual notes, text from speech, one or more reasons for an item, and/or one or more input images. For example, AI module 216 may use a neural network such as a generative adversarial network (GAN), though embodiments contemplate AI module 216 using any kind of neural network and/or AI model capable of generating one or more images from one or more inputs. AI module 216 may also generate one or more images that provide an indication and/or approximation of one or more items a customer wishes to order. In embodiments, AI module 216 performs a reverse image search based on one or more AI-generated images of an item using a neural network, such as a convolutional neural network (CNN). AI module 216 may perform the reverse image search by converting and/or translating an image into one or more attributes and/or characteristics and performing a search to identify one or more images based on the one or more attributes and/or characteristics. Embodiments contemplate that AI module 216 may use any kind of neural network and/or AI model for performing a reverse image search based on one or more input images.

In an embodiment, NLP module 218 implements natural language phrases related to information needs, customer input, verbal interaction with a customer, and the like. NLP module 218 may be applied to customer input in specifying any data associated with an order, such as, for example, a textual and/or verbally spoken description of one or more items, any kind of customer constraint, a customer request date, a quantity, a requested delivery service, and/or any order modifications. NLP module 218 may receive input from a user when placing an order, for example, when the user is describing particular characteristics and/or attributes of one or more items the user wishes to order. According to embodiments, NLP module 218 extracts one or more item descriptions and/or one or more requirement constraints by performing one or more string analyses. The one or more item descriptions may comprise any kind of description that may be applied to an item (e.g., one or more item attributes and/or one or more item categories), and the one or more requirement constraints may comprise any kind of constraint that may be applied to any order, (e.g., a delivery date requirement and/or a particular brand of an item, constraints by a seller, vendor, and/or a supplier, and the like). By way of example only and not by way of limitation, a constraint by a seller may be that electronic orders cannot be drop-shipped and/or to use one or more business priorities such as a particular brand for fulfilment, when available, before other brands are used for fulfillment.

In an embodiment, user interface module 220 generates and displays a user interface (UI), such as, for example, a graphical user interface (GUI), that displays order data 234, supporting information, or any other data of order capture system 110 in charts, graphs, histograms, or any other visual representations. According to embodiments, user interface module 220 may display a GUI comprising interactive graphical elements for displaying and/or interfacing with data of any kind stored in database 114 of order capture system 110. User interface module 220 may also receive order data 234 and supporting information for entering an order. In such embodiments, user interface module 220 may present a GUI that displays one or more results of an item search, clustering, and/or prioritization and enables a user view the one or more results. User interface module 220 may also present a GUI enabling a user to approve or reject a recommended addition of an item to a catalog before the item is added to the catalog. In embodiments, user interface module 220 presents one or more recommendations of one or more contracts to be made with one or more suppliers. In addition, or as an alternative, user interface module 220 may generate non-visual interfaces, such as voice-based digital assistants, email messages or other text-based messages, and/or the like, and interact with customers using such non-visual interfaces.

In an embodiment, contract module 222 provides for administration and/or management of any contract and/or contract data 246. Contract module 222 may establish one or more contracts with one or more suppliers and/or vendors based, at least in part, on the operation of order capture system 110. In some embodiments, contract module 222 may prompt a user for approval for establishing a contract with a supplier and/or vendor, while in other embodiments, contract module 222 may automatically establish a contract with a supplier and/or vendor. Contract module 222 may provide any type of contract with a supplier and/or vendor, such as, for example, drop-ship, made-for-customer, made-to-stock, procurement, and the like. According to embodiments, contract module 222 tracks one or more phases and/or stages of contract formulation and/or negotiation from an initial inquiry for a contract to a final contract agreement. Contract module 222 may also track any kind of contract compliance, for example, to measure and determine whether terms of a contract are met or not. Embodiments contemplate that contract module 222 may establish one or more blockchain-based smart contracts with one or more vendors and/or suppliers, and may further administer blockchain-based smart contracts, for example, by administering and/or managing one or more rules by which one or more criteria of the blockchain-based smart contracts are evaluated and/or measured.

Database 114 of order capture system 110 may comprise one or more databases or other data storage arrangements at one or more locations local to, or remote from, server 112. Database 114 of order capture system 110 comprises, for example, prioritization data 230, catalog data 232, order data 234, trend data 236, cluster data 238, AI model data 240, customer data 242, search data 244, and contract data 246. Although database 114 of order capture system 110 is illustrated and described as comprising prioritization data 230, catalog data 232, order data 234, trend data 236, cluster data 238, AI model data 240, customer data 242, search data 244, and contract data 246, embodiments contemplate any suitable number or combination of data located at one or more locations local to, or remote from, order capture system 110, according to particular needs.

In an embodiment, prioritization data 230 comprises any data associated with prioritization of one or more items. For example, prioritization data 230 may comprise one or more scores for one or more items to provide an indication that an item is more likely to be desired by a customer from among one or more items returned in a search, or any kind of score resulting from an algorithm and/or heuristic used to prioritize one or more items. Prioritization data 230 may be associated with and/or based on any measure and/or metric of customer value (e.g., revenue per customer, lifetime value of the customer, and the like), any type of cost (e.g., a cost of service, a marginal cost, a product cost, and the like), any kind of constraint (e.g., requirement constraints, seller constraints, a constraint which forbids using drop-shipping for electronics, and the like), any type of one or more business rules and/or priorities (e.g., to prioritize one or more items because the one or more items are considered competitive and/or strategic against product offerings of competitors), or any combination thereof.

In an embodiment, catalog data 232 comprises data describing and/or characterizing one or more items in a catalog, such as, for example, a sales catalog or a master catalog. As disclosed above, order capture system 110 may use a unique identifier in a catalog for identifying an item and any associated data of the item, for example, to define a price of an item and/or to provide a description of an item. For example, catalog data 232 may comprise one or more specifications describing a product and/or a service (e.g., one or more attributes, dimensions, descriptions, identifiers, categories, classes, and/or any kind of media, such as images, video, and the like), categories and/or classes of items that have a same and/or similar specification (e.g., different brands copy paper, lubricants having the same specification, and the like), any data, number, and/or code that identifies a product and/or service (e.g., European Article Number (EAN), SKU, UPC, global trade item number (GTIN), Japanese article number (JAN), and the like), and/or one or more media types providing an illustration and/or demonstration of a product and/or service (e.g., images, video, diagrams, and the like). Embodiments contemplate catalog data 232 being stored in any format, such as, for example, a text file and/or a CSV file, or any kind of database format, such as, for example, structured query language (SQL) and/or an object-oriented database format, and the like. In embodiments, catalog data 232 may be organized according to any schema relating to a product and/or service hierarchy, such as, for example, one or models in a product line and/or one or more tiers of service in a service offering. Catalog data 232 may further comprise versioning information, for example, to track when an item is added to a catalog and/or when an item is removed from a catalog. The versioning information may include characterizing one or more catalog versions according to any attribute, such as according to a time frame (e.g., a catalog for a particular year), a particular region, and the like. Embodiments contemplate that catalog data 232 may also contain bill-of-material (BOM) information (e.g., to provide information necessary for identifying one or more parts of an item for maintenance and/or repair), and may provide any kind of description for providing maintenance to an item (e.g., descriptions for maintenance procedures, specifications and/or identification of replacement parts, maintenance schedules, and the like). By way of example only and not by way of limitation, an industrial customer operating off-road construction equipment may access catalog data 232 to obtain information of maintenance schedules for maintenance of a front-end loader and obtain a list of filter and lubricant part numbers necessary to perform the scheduled maintenance according to a recommended interval. In embodiments, any of the above catalog information may be provided to any module of order capture system 110 and/or to external systems, for example, to provide an indication of when a particular item was added to a catalog or when an item is not part of a catalog.

In an embodiment, order data 234 comprises any data describing one or more orders. For example, order data 234 may describe any and/or all attributes of one or more items in an order, such as a product description, SKU, quantity, scheduled delivery date and/or time, and the like. Order data 234 may further comprise any kind of potential supporting information, such as, for example, a description (e.g., long, short, partial, etc.), an identifier (e.g., product identification number, part number, etc.), a selling attribute (e.g., season, region, etc.), and/or a constraint (e.g., fulfill only with exact match, delivery within thirty days, a particular brand or product, etc.). In embodiments, potential supporting information may be in any format, such as, for example, text, audio, and/or video. Order data 234 may also comprise data describing supply chain attributes of an order, such as which of one or more manufacturing sites and/or suppliers manufacture and/or provide sourcing for all or part of an order, data describing one or more warehouses and/or distribution centers that are associated with an order, any promising data associated with an order, and/or the like. Embodiments contemplate that order data 234 may further comprise data used by an order management system, warehouse management system, transportation management system, and/or warehouse management system to process an order.

In an embodiment, trend data 236 comprises any input data used to determine one or more customer trends and/or any output data resulting from any type of analysis of input data. Trend data 236 may be based upon publicly available data, which may comprise any data and/or information from one or more online sources of data, such as, for example, one or more forums where users discuss purchases and preferences for items, social media channels, information from customers in the form of online reviews and/or articles, a regulatory complaint system, and/or any publicly available online system that may indicate what customers have purchased and/or intend to purchase. Trend data 236 may comprise purchase histories of what customers and/or potential customers have purchased. Embodiments contemplate that trend data 236 may further comprise any model and/or modeling technique used to analyze input trend data 236, such as, for example, a trend line indicating a linear trend of sales volume for an item and/or a class of item, or any other data processing and/or modeling technique (e.g., curve fitting, linear regression, etc.) that may be applied to trend data 236 to remove seasonality, to apply any type of smoothing effect (e.g., using autoregressive integrated moving average (ARIMA)), time series data, and/or the like. According to embodiments, trend data 236 comprises any plot, graph, and/or visualization of trends and/or trend analyses.

In an embodiment, cluster data 238 comprises any data characterizing one or more customer clusters. Cluster data 238 may describe any constraint (e.g., sales constraints, fulfillment constraints, etc.), any demographic and/or psychographic data, customer value data, and/or any other data that may be used to determine and/or describe a customer cluster. By way of example only and not by way of limitation, cluster data 238 for a cluster of airline customers may comprise constraints comprising “next day delivery” and “airworthiness certificate required,” because items for the cluster must be delivered by the next day and must have an airworthiness certificate. In embodiments, cluster data 238 provides an indication of how cluster membership has changed over time. Cluster data 238 may further comprise any kind of business and/or financial metric associated with a cluster, such as, for example, revenue amount, cost, business value, business priority, and the like, as well as any qualitative descriptor associated with a cluster, such as, for example, high value, business priority, low priority, platinum customers, and the like.

In an embodiment, AI model data 240 comprises data describing or characterizing one or more AI and/or ML models. The AI and/or ML models may comprise one or more cluster and/or classification models for customer constraints (e.g., a K-means model and/or a SVM model), one or models for prioritization of one or more items (e.g., models that score one or more items), one or more neural networks for generating an image from one or more items of supporting information (e.g., a GAN), one or more neural networks for converting one or more images into one or more features used for searching (e.g., a CNN), and/or the like. Embodiments contemplate that order capture system 110 may obtain and/or derive AI model data 240 from various feeds or sources of training data. Embodiments further contemplate that AI model data 240 may be updated via feedback to improve any of the models described herein, for example, by incorporating negative and/or positive feedback to one or more AI and/or ML models.

In an embodiment, customer data 242 comprises data of shoppers, customers, consumers, and/or other purchasers of goods or services within supply chain network 100, including individuals, businesses, or other entities. For example, customer data 242 may include purchase history data, customer visit pattern data, customer location data, and known customer requirements data. In embodiments, order capture system 110 may derive customer requirements by analyzing additional personal data of customers including customer calendar data, social media data associated with customers, customer service interactions taking place after order placement, internet of things (IoT) data collected from IoT devices associated with customers, and customer profiles and preferences. Customer profile data may include demographic data, such as, for example, addresses, locations, occupations, or any other demographic data. Customer data 242 may further include customer interactions with customer service channels or self-service channels, including call center interactions, website or app interactions, social media interactions, in-person interactions, email interactions, or any other interactions with customer service associated with supply chain network 100. According to embodiments, customer data 242 includes various data related to all customers of supply chain network 100, such as customer clusters or segments that include a particular customer or any other grouping of customers based on constraints, similarity, customer profiles, customer preferences, and/or the like. NLP module 218 may analyze any natural language customer data 242, such as, for example, a message or interaction data of customers, using NLP techniques or models, such as SVMs, term frequency (TF) models, term frequency inverse document frequency (TF-IDF) models, bag-of-words models, logistic regression models, Naïve Bayes models, decision trees, hidden Markov models, convolutional neural networks, recurrent neural networks, auto-encoder models, or NLP transformers, although other NLP techniques may be used according to particular needs.

In an embodiment, search data 244 comprises any data associated with a search for one or more items and/or one or more services. Search data 244 may include one or more terms used in a search, such as, for example, attributes and descriptions of an item, such as color, size, length, operating characteristics, and the like. Search data 244 may further comprise any metadata associated with a search, such as, for example, number of search hits, title tags, and the like, as well as any search history for one or more items, for example, to provide one or more indications of how rare and/or available an item is and/or to provide one or more indications of effectiveness of one or more searches.

In an embodiment, contract data 246 comprises any kind of data and/or data structure that may be used to describe and/or characterize one or more contracts. For example, contract data 246 may comprise any of one or more terms for a contract, such as one or more SLAs specified by the contract, terms for payment, and the like. Contract data 246 may be any data for administering, managing, and/or measuring one or more contracts and/or smart contracts. Embodiments contemplate that contract data 246 may also describe and/or characterize any kind of subcontract, for example, when a contracted supplier and/or vendor providing an item has one or more subcontracts for parts and/or subassemblies used to make the item. In embodiments, contract data 246 comprises both current contracts and past and/or fulfilled contracts. Embodiments further contemplate that contract data 246 may comprise any kind of compliance data, such as, for example, a number of times a supplier did not comply with one or more terms of a contract, as well as any data and/or template that may be used to create and/or update a contract.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 250. Although server 122 is illustrated and described as comprising a single data retrieval module 250, embodiments contemplate any suitable number or combination of data retrieval modules located at one or more locations local to, or remote from, archiving system 120, such as on multiple servers or one or more computers 150 at one or more locations in supply chain network 100.

In one embodiment, data retrieval module 250 of archiving system 120 receives historical supply chain data 260 from planning and execution system 130 and one or more supply chain entities 140 and stores received historical supply chain data 260 in database 124. According to one embodiment, data retrieval module 250 may prepare historical supply chain data 260 for use as training data by checking historical supply chain data 260 for errors and transforming historical supply chain data 260 to normalize, aggregate, and/or rescale historical supply chain data 260 to enable direct comparison of data received from planning and execution system 130, one or more supply chain entities 140, and/or one or more other locations local to, or remote from, archiving system 120. According to embodiments, data retrieval module 250 may receive data from one or more sources external to supply chain network 100, such as, for example, weather data, special events data, social media data, calendar data, and the like, and stores the received data as historical supply chain data 260.

Database 124 of archiving system 120 may comprise one or more databases or other data storage arrangements at one or more locations local to, or remote from, server 122. Database 124 of archiving system 120 comprises, for example, historical supply chain data 260. Although database 124 of archiving system 120 is illustrated and described as comprising historical supply chain data 260, embodiments contemplate any suitable number or combination of data located at one or more locations local to, or remote from, archiving system 120, according to particular needs.

Historical supply chain data 260 comprises historical data received from order capture system 110, archiving system 120, planning and execution system 130, one or more supply chain entities 140, and/or one or more computers 150. Historical supply chain data 260 may comprise, for example, weather data, special events data, social media data, calendar data, and the like. In an embodiment, historical supply chain data 260 may comprise, for example, historic order data, shipment data and return data. In an embodiment, historical supply chain data 260 may comprise, for example, historic sales patterns, prices, promotions, weather conditions and other factors influencing future demand of the number of one or more items sold in one or more stores over a time period, such as, for example, one or more days, weeks, months, or years, including, for example, a day of the week, a day of the month, a day of the year, a week of the month, a week of the year, a month of the year, special events, paydays, and the like.

As discussed above, planning and execution system 130 comprises server 132 and database 134. Although planning and execution system 130 is illustrated as comprising a single server 132 and a single database 134, embodiments contemplate any suitable number of servers or databases internal to, or externally coupled with, planning and execution system 130.

Server 132 of planning and execution system 130 comprises planning module 270 and prediction module 272. Although server 132 is illustrated and described as comprising a single planning module 270 and a single prediction module 272, embodiments contemplate any suitable number or combination of planning modules and prediction modules located at one or more locations local to, or remote from, planning and execution system 130, such as on multiple servers or one or more computers 150 at one or more locations in supply chain network 100.

Planning module 270 of planning and execution system 130 works in connection with prediction module 272 to generate a plan based on one or more predicted retail volumes, classifications, or other predictions. By way of example and not of limitation, planning module 270 may comprise a demand planner that generates a demand forecast for one or more supply chain entities 140. Planning module 270 may generate the demand forecast, at least in part, from predictions and calculated factor values for one or more causal factors received from prediction module 272. By way of a further example, planning module 270 may comprise an assortment planner and/or a segmentation planner that generates product assortments that match causal effects calculated for one or more customers or products by prediction module 272, which may provide for increased customer satisfaction and sales, as well as reduced costs for shipping and stocking products at stores where they are unlikely to sell. Embodiments contemplate that planning module 270 may comprise a promising server that may provide available-to-promise (ATP) and/or other information for promising one or more orders. Planning module 270 may also comprise a regular order scheduler for providing order scheduling.

Prediction module 272 of planning and execution system 130 applies samples of transaction data 280, supply chain data 282, product data 284, inventory data 286, capacity data 288, store data 290, customer data 292, demand forecasts 294, and other data to prediction models 298 to generate predictions and calculated factor values for one or more causal factors. Prediction module 272 of planning and execution system 130 predicts a volume Y (target) from a set of causal factors X along with causal factors strengths that describe the strength of each causal factor variable contributing to the predicted volume. According to some embodiments, prediction module 272 generates predictions at daily intervals. However, embodiments contemplate longer and shorter prediction phases that may be performed, for example, weekly, twice a week, twice a day, hourly, or the like.

Database 134 of planning and execution system 130 may comprise one or more databases or other data storage arrangements at one or more locations local to, or remote from, server 132. Database 134 of planning and execution system 130 comprises, for example, transaction data 280, supply chain data 282, product data 284, inventory data 286, capacity data 288, store data 290, customer data 292, demand forecasts 294, supply chain models 296, and prediction models 298. Although database 134 of planning and execution system 130 is illustrated and described as comprising transaction data 280, supply chain data 282, product data 284, inventory data 286, capacity data 288, store data 290, customer data 292, demand forecasts 294, supply chain models 296, and prediction models 298, embodiments contemplate any suitable number or combination of data located at one or more locations local to, or remote from, planning and execution system 130, according to particular needs.

Transaction data 280 of planning and execution system 130 may comprise recorded sales and returns transactions and related data, including, for example, a transaction identification, time and date stamp, channel identification (such as stores or online touchpoints), product identification, actual cost, selling price, sales volume, customer identification, promotions, and or the like. In addition, transaction data 280 is represented by any suitable combination of values and dimensions, aggregated or disaggregated, such as, for example, sales per week, sales per week per location, sales per day, sales per day per season, or the like.

Supply chain data 282 may comprise data of the one or more supply chain entities 140 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 140.

Product data 284 of database 134 may comprise items, products, and/or services identified by, for example, a product identifier (such as SKU, UPC, or the like), and one or more attributes and attribute types associated with the product ID. Product data 284 may comprise data about one or more products organized and sortable by, for example, product attributes, attribute values, product identification, sales volume, demand forecast, or stored category or dimension. Attributes of one or more products may be, for example, a categorical characteristic or quality of a product, and an attribute value may be a specific value or identity for the one or more products according to the categorical characteristic or quality, including, for example, physical parameters (such as, for example, size, weight, dimensions, color, and the like).

Inventory data 286 of database 134 may comprise data relating to current or projected inventory quantities or states, order rules, or the like. For example, inventory data 286 may comprise the current level of inventory for each item at one or more stocking points across supply chain network 100. In addition, inventory data 286 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 130 accesses and stores inventory data 286 in database 134, which may be used by planning and execution system 130 to place orders, set inventory levels at one or more stocking points, initiate manufacturing of one or more components, or the like.

In embodiments, inventory data 286 may include one or more inventory policies. The inventory policies may comprise any suitable inventory policy describing the reorder point and target quantity, or other inventory policy parameters that set rules for planning and execution system 130 to manage and reorder inventory. According to embodiments, the inventory policies comprise target service levels that ensure that a service level of one or more supply chain entities 140 is met with a set probability. For example, one or more supply chain entities 140 may set a service level at 95%, meaning one or more supply chain entities 140 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 130 may determine a replenishment order according to one or more replenishment rules, which, among other things, indicates to one or more supply chain entities 140 to determine or receive inventory to replace the depleted inventory. By way of example only and not by way of limitation, an inventory policy for non-perishable goods with linear holding and shorting costs comprises a min./max. (s, S) inventory policy. Other inventory policies may be used for perishable goods, such as fruit, vegetables, dairy, and fresh meat, as well as electronics, fashion, and similar items for which demand drops significantly after a next generation of electronic devices or a new season of fashion is released.

Capacity data 288 of database 134 may comprise data relating to current or projected resource capacity values or states, order rules, or the like. For example, capacity data 288 may comprise the current level of capacity for each task at one or more locations across supply chain network 100. In addition, capacity data 288 may comprise order rules that describe one or more rules or limits on setting a capacity policy, including, but not limited to, a minimum order capacity, a maximum order capacity, a discount, a step-size order capacity, and batch quantity rules. According to some embodiments, planning and execution system 130 accesses and stores capacity data 288 in database 134, which may be used by planning and execution system 130 to place orders, set capacity levels at one or more locations in supply chain network 100, initiate manufacturing of one or more components, or the like.

In embodiments, capacity data 288 may include one or more capacity policies. The capacity policies may comprise any suitable capacity policy describing the reorder point and target quantity, or other capacity policy parameters that set rules for planning and execution system 130 to manage capacity. The capacity policies may be based on target service level, demand, cost, or the like. According to embodiments, the capacity policies comprise target service levels that ensure that a service level of one or more supply chain entities 140 is met with a set probability. For example, one or more supply chain entities 140 may set a service level at 95%, meaning one or more supply chain entities 140 sets the desired capacity level at a level that meets demand 95% of the time.

Store data 290 may comprise data describing the stores of one or more retailers and related store information. Store data 290 may comprise, for example, a store ID, store description, store location details, store location climate, store type, store opening date, lifestyle, store area (expressed in, for example, square feet, square meters, or other suitable measurement), latitude, longitude, and other similar data.

Customer data 292 may comprise customer identity information, including, for example, customer relationship management data, loyalty programs, and mappings between product purchases and one or more customers so that a customer associated with a transaction may be identified. Customer data 292 may comprise data relating customer purchases to one or more products, geographical regions, store locations, or other types of dimensions. In embodiments, customer data 292 may comprise product browsing data, customer service interaction data, and user interface analytics data of customers.

Demand forecasts 294 of database 134 may indicate expected future demand based on, for example, data relating to past sales, past demand, purchase data, promotions, events, or the like of one or more supply chain entities 140. Demand forecasts 294 may cover a time interval such as, for example, by the minute, by the hour, daily, weekly, monthly, quarterly, yearly, or other suitable time interval, including substantially in real time. In some embodiments, demand may be modeled as a negative binomial or Poisson-Gamma distribution. According to other embodiments, the model also takes into account shelf-life of perishable goods (which may range from days (e.g., fresh fish or meat) to weeks (e.g., butter) or even months, before unsold items have to be written off as waste) as well as influences from promotions, price changes, rebates, coupons, and even cannibalization effects within an assortment range. In addition, customer behavior is not uniform but varies throughout the week, and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. By way of example only and not by way of limitation, an exemplary supermarket may stock twenty thousand items at one thousand locations. When each location of this exemplary supermarket is open every day of the year, planning and execution system 130 needs to calculate approximately 2×10\hat{ }10 demand forecasts 294 each day to derive the optimal order volume for the next delivery cycle (e.g., three days).

Supply chain models 296 of database 134 comprise characteristics of a supply chain setup to deliver the customer expectations of a particular customer business model. These characteristics may comprise differentiating factors, such as, for example, drop-ship, procurement, MTO (Make-to-Order), ETO (Engineer-to-Order), or MTS (Make-to-Stock). However, supply chain models 296 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for by particular customers. Each of these characteristics may lead to a different supply chain model. Prediction models 298 comprise one or more of the trained models used by planning and execution system 130 for predicting, among other variables, pricing, targeting, or retail volume, such as, for example, a forecasted demand volume for one or more products at one or more stores of one or more retailers based on the prices of the one or more products.

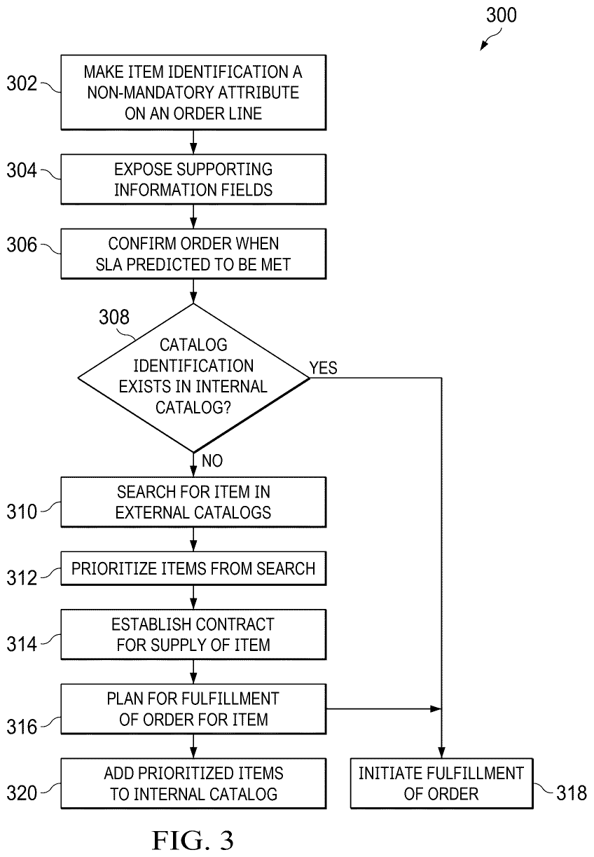

FIG. 3 illustrates example method 300 for order fulfillment of unknown ordered items, in accordance with an embodiment. Method 300 may be performed by an order capture system, such as order capture system 110 of FIG. 1. Method 300 proceeds by one or more activities, which although described in a particular order, may be performed in one or more permutations, combinations, orders, or repetitions, according to particular needs.

At activity 302, order module 204 of order capture system 110 makes item identification a non-mandatory attribute on an order line for an order. At activity 304, order module 204 exposes one or more supporting information fields for one or more order lines not having an item identification. At activity 306, order module 204 confirms the order when an order SLA is predicted to be met by one or more configured constraints. For example, when the order has a delivery date SLA of one month and a rule has been configured to confirm all orders having delivery date SLA of greater than three weeks, order module 204 confirms the order. At activity 308, search module 214 of order capture system 110 determines whether a catalog item identification exists for the item in an internal catalog based on the information in the one or more supporting information fields.

When search module 214 does not find the item in the internal catalog, at activity 310, search module 214 searches for the item in one or more outside and/or external catalogs using the information in the one or more supporting information fields. At activity 312, prioritization module 212 of order capture system 110 prioritizes items found from the search performed at activity 310. In embodiments, prioritization module 212 prioritizes the items based on applying one or more AI algorithms that may determine which items of the search best match the information in the one or more supporting information fields. Prioritization module 212 may determine a prioritization score for each item determined from the search, where the prioritization score may be used to select an item determined from the search.

At activity 314, contract module 222 of order capture system 110 establishes a contract for supply of the item. In embodiments, the contract established by contract module 222 may comprise one or more of drop-ship, made-to-order, made-for-customer, made-to-stock, and/or procurement. At activity 316, contract module 222 plans for fulfillment of the order for the item. According to embodiments, contract module 222 establishes one or more contracts, such as, for example, for carrier service for transportation and/or logistics, for performing assembly of the item, and the like. Contract module 222 may establish the one or more contracts based on availability of physical inventory for fulfillment. As discussed in greater detail above, any of one or more contracts may be a smart contract. From activity 316, or when search module 214 finds the item in the internal catalog at activity 308, order capture module 202 of order capture system 110 initiates fulfillment of the order at activity 318. At activity 320, catalog module 206 of order capture system 110 adds one or more of the prioritized items to the internal catalog.

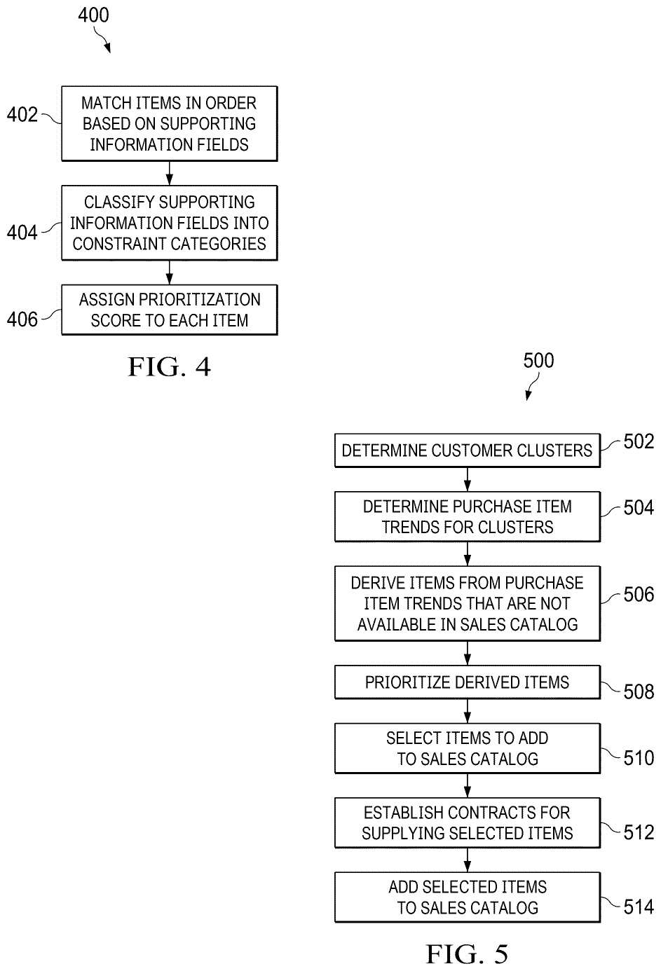

FIG. 4 illustrates example method 400 for performing ML-driven item prioritization based on input constraints, in accordance with an embodiment. Method 400 may be performed by an order capture system, such as order capture system 110 of FIG. 1. Method 400 proceeds by one or more activities, which although described in a particular order, may be performed in one or more permutations, combinations, orders, or repetitions, according to particular needs.

At activity 402, search module 214 of order capture system 110 matches one or more items in an order based, at least in part, on one or more supporting information fields. In embodiments, supporting information may comprise one or more constraints, such as, for example, one or more selling constraints, one or more fulfillment constraints, and/or one or more constraints regarding composition of the item. As disclosed above, the order may comprise any type of order, such as, for example, a long order, a short order, a partial order, and the like. Search module 214 may perform the search on the basis of any information in one or more supporting information fields, such as, for example, a name, a value, a range, and the like. According to embodiments, the order may comprise an update to an order, for example, where one or more items are being added to an existing order.

At activity 404, AI module 216 of order capture system 110 classifies the one or more supporting information fields into one or more constraint categories using a classification technique, such as SVM. In embodiments, the one or more supporting information fields may comprise one or more media types, such as, for example text, voice, video, and/or image. In such embodiments, AI module 216 may extract one or more string tokens and/or natural language strings from the one or more media types of the one or more supporting information fields to, for example, determine an item description of what one or more item qualities or attributes are desired by a customer. By way of example and not by way of limitation, AI module 216 may perform a string analysis using one or more classification techniques to extract an item description, such as one or more attributes and/or categories. In addition, or as an alternative, AI module 216 may perform a string analysis to extract one or more requirement constraints, such as date fulfillment requirements and/or required brand of an item. Constraint categories may comprise any category to classify constraints, such as, for example, selling constraints, fulfillment constraints, and/or item composition constraints. By way of example only and not by way of limitation, a constraint may comprise that a reseller must be able to inspect an item to ensure that the item is not damaged when delivered to the customer. Constraints may also be related to one or more business priorities that may be related to a particular item or not related to a particular item. For example, when two suppliers are both capable of fulfilling an order, but only one supplier is a preferred partner when an order is placed, the preferred partner is selected for the order.

At activity 406, prioritization module 212 of order capture system 110 assigns a prioritization score to each of the one or more items. In embodiments, prioritization module 212 generates the prioritization score using one or more ML approaches to one or more constraint categories determined at activity 404. For example, prioritization module 212 may use a K-means clustering algorithm to generate the prioritization score so that the item with the highest prioritization score is selected. In addition, or as an alternative, prioritization module 212 may generate the prioritization score using a mathematical method, such as weighted scoring prioritization.

Consider the following example to further demonstrate the operation of the systems and methods disclosed herein, in which an office supplies retailer has a contract with a B2B customer to provide any ordered stationery item within thirty days. The B2B customer places an order for 1,000 units of an item described as Item I and as being a waterproof file folder. Currently, Item I is not listed in any master catalog or sales catalog of the office supplies retailer. Order module 204 of order capture system 110 captures the order and determines that Item I has never been part of a catalog in the past. Further, search module 214 of order capture system 110 performs an internet search and locates a supplier that may provide 1,000 units of the waterproof file folders in twenty-eight days. Order module 204 immediately places a drop-ship order with the supplier for 1,000 units of Item I to be delivered to the B2B customer at the delivery location specified by the order. Additionally, because demand for Item I is low and the supplier may provide items within the thirty-day service level agreement of the office supplies retailer, contract module 222 of order capture system 110 recommends adding a contract with the supplier. Once approved, catalog module 206 of order capture system 110 adds Item I to the master catalog and sales catalog of the office supplies retailer so that any customer in the future may order and receive the item. In some embodiments, catalog module 206 may automatically add the item to the catalog or, in other embodiments, the addition to the catalog may require approval.

Consider the following additional example to demonstrate the operation of the systems and methods disclosed herein where the office supplies retailer has a contract with a B2B customer to provide any ordered stationery item within thirty days, and the B2B customer places an order for 1,000 units of an item described as a letter size waterproof file folder. Again, Item I is not listed in any master catalog or sales catalog, and never has been part of either catalog in the past. In this example, search module 214 performs an internet search and locates Supplier A and Supplier B, where Supplier A may provide 1,000 units of the letter size waterproof file folders as Item I1 in thirty days and Supplier B may provide 1,000 units of the letter size waterproof file folder as Item I2 in twenty-five days. Order module 204 immediately places a drop-ship order with Supplier B for 1,000 units of Item I2 to be delivered to the B2B customer per the delivery location specified by the order. Additionally, because demand for Item I is low and both Supplier A and Supplier B may provide items within the thirty-day service level agreement of the office supplies retailer, contract module 222 recommends adding a contract with both Supplier A and Supplier B. Once approved, catalog module 206 adds Item I1 and Item I2 to the master catalog and sales catalog so that any customer in the future may order and receive these items.

FIG. 5 illustrates example method 500 for proactive enhancement of a catalog, in accordance an embodiment. Method 500 may be performed by an order capture system, such as order capture system 110 of FIG. 1. Method 500 proceeds by one or more activities, which although described in a particular order, may be performed in one or more permutations, combinations, orders, or repetitions, according to particular needs.

At activity 502, cluster module 210 of order capture system 110 determines one or more customer clusters for a seller. In embodiments, cluster module 210 determines one or more customer clusters on a recurring basis, such as, for example, every week or every day. Cluster module 210 may determine the one or more customer clusters based on any classification, segmentation, and/or clustering technique and/or algorithm. By way of example only and not by way of limitation, cluster module 210 may use a K-means clustering approach, a SVM approach, a logistic regression approach, and the like to perform the clustering. Cluster module 210 may determine the one or more customer clusters based on any factor, attribute, and/or characteristic for grouping one or more customers in a cluster, such as, for example, using SIC codes to classify different types of businesses into a cluster based on the SIC code for that business, or clustering companies based on attributes of products sold by the companies.

At activity 504, trend module 208 of order capture system 110 determines one or more purchase item trends for the one or more clusters. In embodiments, trend module 208 determines the one or more purchase item trends based on purchase history, customer service data and/or customer requirements data (e.g., customer feedback and/or one or more customer preferences for one or more items), and/or publicly available information. By way of example only and not by way of limitation, publicly available information may indicate that a new product is in high demand among a particular type of customer. According to embodiments, publicly available information comprises any website where customers and/or users describe and/or comment on what items they have purchased and express one or more preferences for future purchases (e.g., an industry-related forum where users describe one or more types of equipment their company has purchased and/or intends to purchase), publicly accessible information on a social media site, information written by customers on websites (e.g., reviews on a retailer website for a purchased item, articles written by customers, and the like), a website that tracks market and/or social trends indicating purchase and/or other trends by customers, a regulatory complaint system that may indicate what customers buy and what customers want to buy, and/or the like. At activity 506, search module 214 of order capture system 110 derives one or more items from the purchase item trends determined at activity 504 that are not available in a sales catalog of the seller.

At activity 508, prioritization module 212 of order capture system 110 prioritizes the derived one or more items that are not available in the sales catalog. In embodiments, prioritization module 212 performs the prioritization of the derived one or more items in any way that characterizes and/or determines value of an item to a customer cluster and/or a value of a particular customer cluster. By way of example only and not by way of limitation, a particular customer cluster may comprise high value customers, where prioritization module 212 prioritizes all of the one or more items derived for that high value customer cluster higher than all of the one or more items derived for a lower value customer cluster. Prioritization module 212 may also prioritize a derived item by a cost of the derived item, where cost may be measured and/or quantified in any way, such as, for example, based on total cost, cost margin, revenue, profit margin, and the like. Embodiments contemplate that prioritization module 212 may determine a cost for a derived item may be determined in any quantifiable way (e.g., numerically, such as financial value) and/or qualitative way (e.g., by descriptors such as “high” or “low”). In addition, or as an alternative, prioritization module 212 may prioritize the derived one or more items may be based on business priorities and/or rules, such as, for example, to prioritize items in a product category deemed important from a strategic and/or business needs perspective. Rules for prioritization may be based on any kind of rule characterizing value of a derived item to a business, such as, for example, based on a profit of revenue less cost for an item. Prioritization module 212 may further apply a threshold to a prioritization of a derived item, such as, for example, a threshold for profitability, a threshold of derived alignment to a business strategy, a demand threshold, and/or the like. Embodiments further contemplate that prioritization module 212 may apply financial and/or business metrics of a derived item to a threshold to determine prioritization. For example, prioritization module 212 may require that an item have a certain volume of sales to be characterized as a priority item, or that an item must have achieved a certain level of customer satisfaction. In addition, or as an alternative, prioritization module 212 may use one or more associations of the one or more items as the basis for prioritization. For example, when a particular derived item for a high value customer cluster is associated with one or more other items typically purchased together, prioritization module 212 may assign all of the associated items a high prioritization. Embodiments contemplate that prioritization module 212 may prioritize one or more items as a group for a customer cluster because the one or more items are part of a market basket of goods that are purchased together, such as, for example, sports equipment (e.g., golf clubs and golf balls), office supplies (e.g., stationery and writing utensils), cleaning supplies (e.g., mops and floor cleaning solutions), and the like. As discussed in further detail below, prioritization module 212 may also use any of the approaches and/or data used in activity 510 for selecting one or more items to add to the catalog to prioritize the one or more items in activity 508.

At activity 510, catalog module 206 of order capture system 110 selects one or more items to add to the sales catalog. In embodiments, catalog module 206 bases the selection of the one or more items on one or more thresholds, according to various business needs. A threshold may be based on any business factor, such as, for example, needs, constraints, commitments to a customer, priorities, and/or goals such as sustainability and/or environmentally friendliness, warehouse space limitations, manufacturing capacity limitations, and the like. By way of example only and not by way of limitation, catalog module 206 may select one or more items for a high value group of customers to provide enhanced service and/or value to the high value group of customers. In addition, or as an alternative, catalog module 206 may base the selection of the one or more items to add to the catalog on a financial analysis, such as a predicted selling price and corresponding profit, though embodiments contemplate that catalog module 206 may use any type of financial analysis to select the one or more items for the catalog, such as a comprehensive financial analysis considering various factors such as selling price, discounts, volume, inventory carrying costs, shipping cost, warehousing cost, overhead costs and expenses, financing costs (e.g., weighted average cost of capital or WACC), and the like. According to embodiments, catalog module 206 may make the selection of the one or more items for the catalog based on one or more customer purchase histories, such as, for example, purchase amounts in various categories, purchase trends, seasonality effects, and the like. As discussed in greater detail above, catalog module 206 may use any of the approaches and/or data for prioritizing one or more items at activity 508 to select the one or more items to add to the catalog.

Embodiments contemplate order capture system 110 using different factors and/or the same and/or overlapping factors for the prioritization of activity 508 and the selection of activity 510. Embodiments further contemplate order capture system 110 performing any combination of the prioritization of activity 508 and the selection of activity 510. For example, order capture system 110 may perform the prioritization and selection first for high value items and high value customer clusters, and then performing the prioritization and selection for low value items and low value clusters. According to embodiments, a combination of the prioritization of activity 508 and the selection of activity 510 may be configured based on any factor and/or attribute, according to particular needs.

At activity 512, contract module 222 of order capture system 110 establishes one or more contracts for supplying the one or more selected items. In embodiments, contract module 222 may generate the one or more contracts based, at least in part, on one or more supply nodes, such as, for example, one or more geographic locations and/or suppliers from which a particular item may be sourced, or on a type of resource capacity, such as, for example, whether a supplier may provide sufficient quantity of an item within a particular service level, whether a warehouse has capacity for storage of an item, availability of physical inventory of an item, and the like. Embodiments further contemplate that a contract may comprise a blockchain-based smart contract. At activity 514, catalog module 206 adds the selected one or more items to the sales catalog. As discussed in greater detail above, the catalog may comprise any type of product and/or service listing in any type of format that may be accessed, for example, to place an order.

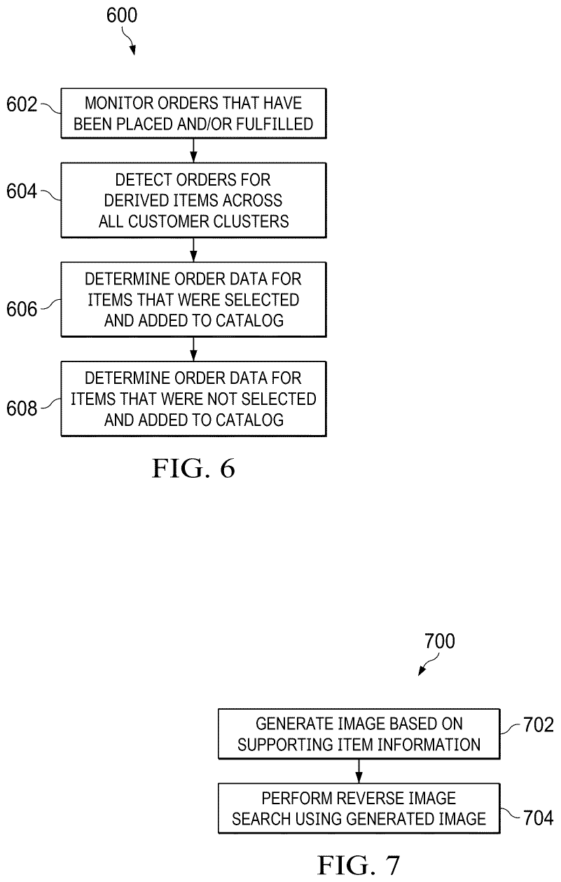

FIG. 6 illustrates example method 600 for receiving feedback on prioritization and selection, in accordance with an embodiment. Method 600 may be performed by an order capture system, such as order capture system 110 of FIG. 1. Method 600 proceeds by one or more activities, which although described in a particular order, may be performed in one or more permutations, combinations, orders, or repetitions, according to particular needs.

At activity 602, order module 204 of order capture system 110 monitors one or more orders that have been placed and/or fulfilled. At activity 604, order module 204 detects one or more orders for one or more derived items across all customer clusters. In embodiments, order capture system 110 may derive, prioritize, and select one or more items for a catalog using method 500 of FIG. 5, as discussed in greater detail above.

At activity 606, order prioritization module 212 of order capture system 110 determines order data 234 for one or more items that were selected and added to the catalog. In embodiments, order data 234 for a selected item may include positive feedback and/or a reward for the selection of that item. Embodiments contemplate prioritization module 212 using positive feedback to correct and/or improve any strategy, approach, and/or algorithm used to prioritize and/or select one or more items for a catalog. By way of example only and not by way of limitation, prioritization module 212 may compare orders for an item to an analysis justifying and/or substantiating prioritizing and/or selection of the item by comparing actual profit achieved for the item with the anticipated profit for the item to adjust the analysis to reflect the actual profit.

At activity 608, prioritization module 212 determines order data 234 for one or more items that were not selected and added to the catalog. In embodiments, one or more items not selected may include one or more items that were manually added to the catalog. Order data 234 for an item not selected may comprise negative feedback and/or a penalty for the selection of that item. Embodiments contemplate prioritization module 212 using negative feedback to correct and/or improve any approach and/or algorithm used to prioritize and/or select one or more items for a catalog. By way of example only and not by way of limitation, prioritization module 212 may use orders for an item that was not selected for addition to the catalog to adjust a prioritization threshold so that the item may be selected for addition to the catalog.

To further demonstrate the operation of the systems and methods disclosed herein, consider the following example, in which a leading international construction material and machine provider serves customers across various regions and industries. Regulatory changes in Europe to lower taxes on construction-related products and services have increased demand for construction activities. At the same time, 3D printing in the construction industry in North America is gaining popularity. Trend module 208 of order capture system 110 thus determines that sales trends for construction in Europe are increasing due to the changes in tax regulations and that 3D printing activity in the North America construction industry is increasing. A European crane manufacturer has recently launched a new model of tower crane with increased efficiency, though the tower crane is not yet in the international construction material catalog and the catalog of the machine provider. Further, while nylon-12 glass-filled 3D printing filament is one of the latest 3D printing materials for use in the construction industry and is gaining popularity, it is not by the international construction material and machine provider and is thus not in their catalog. As a result, trend module 208 further determines that demand for the new tower crane in Europe and demand for the nylon-12 glass-filled 3D printing filament in North America are both expected to increase. Because of the increasing demand for construction in Europe, catalog module 206 of order capture system 110 recommends adding the tower crane to the European catalog of the international construction material and machine provider. Further, because of the increasing demand in North America for the nylon-12 glass-filled 3D printing filament, catalog module 206 recommends adding the nylon-12 glass-filled 3D printing filament to the North American catalog of the international construction material and machine provider. Search module 214 of order capture system 110 performs an internet search and locates an online supplier for the 3D printing filament that may drop-ship with competitive rates. Contract module 222 of order capture system 110 then establishes drop-ship contracts with the European crane manufacturer and the online supplier. Thus, when orders are received from a European construction company for the new tower crane and from a North American construction company for the nylon-12 glass-filled 3D printing filament, both orders are fulfilled in a timely manner because order capture system 110 correctly predicted these items to be in demand and made the necessary adjustments to accommodate any future orders.

FIG. 7 illustrates example method 700 for a reverse image search of an item using generative AI, in accordance with an embodiment. Method 700 may be performed by an order capture system, such as order capture system 110 of FIG. 1. Method 700 proceeds by one or more activities, which although described in a particular order, may be performed in one or more permutations, combinations, orders, or repetitions, according to particular needs.

At activity 702, AI module 216 of order capture system 110 generates an image based on supporting item information. The supporting information may comprise notes (e.g., one or more textual inputs such as an item description), text transcribed from speech (e.g., by a user speaking a description), a search reason (e.g., an entry indicating a reason for searching for an item, such as a customer requiring stationery for business needs or a customer requiring a particular kind of part for maintenance of a vehicle fleet), an image that is input into order capture system 110 via user interface module 220, any type of audiovisual media (e.g., a video of an item), and/or the like. In embodiments, supporting item information may be explicit information and/or implicit information. For example, an electrical contractor customer may input an explicit textual description of “residential circuit breakers,” where an associated implicit description may be circuit breakers rated for one hundred ten or two hundred twenty volts (i.e., circuit breakers rated for residential service). As another example, when a plumbing business enters “pipe” as an item description, information implicit to the description “pipe” may be that the pipe is related to plumbing services, as opposed to “pipe” entered by an oil drilling services company, where “pipe” implies the pipe is related to drilling for oil, such as drill pipe. As disclosed above, AI module 216 may generate the one or more images using a neural network, such as, for example, a GAN.

At activity 704, search module 214 of order capture system 110 performs a reverse image search using the generated image. According to embodiments, search module 214 performs the reverse image search using a neural network, such as, for example, a CNN. Search module 214 may extract one or more features and/or one or more attributes of a generated image for searching for one or more items in an internal image database or on any source of publicly available images, such as, for example, online catalogs and/or image searches of online repositories.

Consider the following example to further demonstrate the operation of the systems and methods disclosed herein, in which an office supplies retailer has a contract with one of their B2B customers to provide any ordered stationery within thirty days. The B2B customer places an order for 1,000 units of a waterproof file folder and provides a description of “waterproof file folder with smooth edges.” An employee of the B2B customer uploads an image of a file folder to indicate the preferred design and look of the file folder, though the uploaded image does not have smooth edges. The actual file folder wanted by the B2B customer is Item I, which is not in the office supplies retailer catalog. AI module 216 of order capture system 110 generates a predicted image of the ordered file folder by processing the uploaded image to smooth the edges of the file folder in the image according to the text description. Further, search module 214 of order capture system 110 performs an internet image search using the processed image and locates a supplier that may provide 1,000 units of the Item I file folder in twenty-eight days. Order module 204 of order capture system 110 then immediately places a drop-ship order with the supplier for the delivery location specified by the order. Because the supplier may fulfill orders within twenty-eight days, which is also within the service level agreement of the office supplies retailer of thirty days and because demand for Item I is low, contract module 222 of order capture system 110 recommends a contract between the office supplies retailer and the supplier for drop-shipments for Item I. The office supplies retailer approves the recommendation for the contract with the supplier and catalog module 206 of order capture system 110 adds Item I to the catalog of the office supplies retailer.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for proactive enhancement of a catalog, comprising:
a computer, comprising a processor and memory, and configured to:
determine one or more customer clusters for a seller;
determine one or more purchase item trends for the one or more customer clusters;
derive one or more items from the one or more purchase item trends that are not available in a sales catalog of the seller;
prioritize the one or more derived items that are not available in the sales catalog;
select one or more items of the one or more prioritized items to add to the sales catalog based on at least one threshold;
establish one or more contracts for supplying the one or more selected items; and
add the one or more selected items to the sales catalog.

2. The system of claim 1, wherein the one or more customer clusters are determined on a recurring basis.

3. The system of claim 1, wherein the one or more purchase item trends are based on one or more of: purchase history, customer service data and customer requirements data.

4. The system of claim 1, wherein the at least one threshold is based on one or more of: constraints, commitments to a customer, priorities, sustainability goals, environmentally friendliness goals, warehouse space limitations and manufacturing capacity limitations.

5. The system of claim 1, wherein at least one of the one or more contracts comprises a blockchain-based smart contract.

6. The system of claim 1, wherein the one or more prioritized items are part of a market basket of goods.

7. The system of claim 1, wherein the at least one threshold comprises a financial threshold.

8. A computer-implemented method for proactive enhancement of a catalog, comprising:
determining, by a computer comprising a processor and memory, one or more customer clusters for a seller;
determining, by the computer, one or more purchase item trends for the one or more customer clusters;
deriving, by the computer, one or more items from the one or more purchase item trends that are not available in a sales catalog of the seller;
prioritizing, by the computer, the one or more derived items that are not available in the sales catalog;
selecting, by the computer, one or more items of the one or more prioritized items to add to the sales catalog based on at least one threshold;
establishing, by the computer, one or more contracts for supplying the one or more selected items; and
adding, by the computer, the one or more selected items to the sales catalog.

9. The computer-implemented method of claim 8, wherein the one or more customer clusters are determined on a recurring basis.

10. The computer-implemented method of claim 8, wherein the one or more purchase item trends are based on one or more of: purchase history, customer service data and customer requirements data.

11. The computer-implemented method of claim 8, wherein the at least one threshold is based on one or more of: constraints, commitments to a customer, priorities, sustainability goals, environmentally friendliness goals, warehouse space limitations and manufacturing capacity limitations.

12. The computer-implemented method of claim 8, wherein at least one of the one or more contracts comprises a blockchain-based smart contract.

13. The computer-implemented method of claim 8, wherein the one or more prioritized items are part of a market basket of goods.

14. The computer-implemented method of claim 8, wherein the at least one threshold comprises a financial threshold.

15. A non-transitory computer-readable storage medium embodied with software for proactive enhancement of a catalog, the software when executed by a computer is configured to:
determine one or more customer clusters for a seller;
determine one or more purchase item trends for the one or more customer clusters;
derive one or more items from the one or more purchase item trends that are not available in a sales catalog of the seller;
prioritize the one or more derived items that are not available in the sales catalog;
select one or more items of the one or more prioritized items to add to the sales catalog based on at least one threshold;
establish one or more contracts for supplying the one or more selected items; and
add the one or more selected items to the sales catalog.

16. The non-transitory computer-readable storage medium of claim 15, wherein the one or more customer clusters are determined on a recurring basis.

17. The non-transitory computer-readable storage medium of claim 15, wherein the one or more purchase item trends are based on one or more of: purchase history, customer service data and customer requirements data.

18. The non-transitory computer-readable storage medium of claim 15, wherein the at least one threshold is based on one or more of: constraints, commitments to a customer, priorities, sustainability goals, environmentally friendliness goals, warehouse space limitations and manufacturing capacity limitations.

19. The non-transitory computer-readable storage medium of claim 15, wherein at least one of the one or more contracts comprises a blockchain-based smart contract.

20. The non-transitory computer-readable storage medium of claim 15, wherein the one or more prioritized items are part of a market basket of goods.
